(19) United States
(12) Patent Application Publication
(10) Pub. No.: US 2021/0389821 A1
(43) Pub. Date: Dec. 16, 2021

(54) VISUAL AID DEVICE

(71) Applicant: Stephen Eisenmann, Vero Beach, FL (US)

(72) Inventor: Stephen Eisenmann, Vero Beach, FL (US)

(21) Appl. No.: 17/346,208

(22) Filed: Jun. 12, 2021

Related U.S. Application Data
(60) Provisional application No. 63/038,204, filed on Jun. 12, 2020.

(51) Int. Cl. G06F 3/01; G02B 27/01; G06F 3/00

(52) U.S. Cl. CPC G06F 3/014; G02B 2027/0138; G06F 3/005; G02B 27/0172

(57) ABSTRACT

A visual aid system, device, and/or method that utilizes a first camera located at a first position on a first part of a hand on a person and eyewear including a heads up display where the eyewear being in communication with the first camera to provide data for display on the heads up display located in the eyewear.

### BACKGROUND

The present application claims priority to United States provisional patent application Ser. No. 63/038,204, filed on Jun. 12, 2020, which is incorporated in its entirety herein by reference.

### FIELD

This disclosure relates to systems, devices, and methods for use in commerce and transportation.

### BRIEF DESCRIPTION OF THE DRAWINGS

The disclosure may be understood by reference to the following description taken in conjunction with the accompanying drawings, in which like reference numerals identify like elements, and in which:

FIG. 1 is an illustration of an autonomous vehicle implementation, according to one embodiment.

FIG. 2 is an illustration of an autonomous vehicle utilized to pick up and drop off people, according to one embodiment.

FIG. 3 is another illustration of an autonomous vehicle utilized to pick up and drop off people and/or items, according to one embodiment.

FIG. 4 is an illustration of an autonomous vehicle with various tools, according to one embodiment.

FIG. 5A is an illustration of a financial transaction process and security system, according to one embodiment.

FIG. 5B is a flow diagram for the financial transaction process and security system, according to one embodiment.

FIG. 6A is an illustration of a visual aid device, according to one embodiment.

FIG. 6B is an additional illustration of the visual aid device, according to one embodiment.

FIG. 7A is an illustration of touchless transaction device, according to one embodiment.

FIG. 7B is another illustration of touchless transaction device, according to one embodiment.

FIG. 7C is an illustration of touchless transaction device, according to one embodiment.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION OF SPECIFIC EMBODIMENTS

Illustrative embodiments of the disclosure are described herein. In the interest of brevity and clarity, not all features of an actual implementation are described in this specification. In the development of any such actual embodiment, numerous implementation-specific decisions must be made to achieve the design-specific goals, which will vary from one implementation to another. It will be appreciated that such a development effort, while possibly complex and time-consuming, would nevertheless be a routine undertaking for persons of ordinary skill in the art having the benefit of this disclosure.

This document does not intend to distinguish between components that differ in name but not function. In the following discussion and in the claims, the terms “including” and “includes” are used in an open-ended fashion, and thus should be interpreted to mean “including, but not limited to.” Also, the term “couple” or “couples” is intended to mean either a direct or an indirect connection (e.g., electrical, mechanical, etc.). “Direct contact,” “direct attachment,” or providing a “direct coupling” indicates that a surface of a first element contacts the surface of a second element with no substantial attenuating medium there between. The presence of small quantities of substances, such as bodily fluids, that do not substantially attenuate electrical connections does not vitiate direct contact. The word “or” is used in the inclusive sense (i.e., “and/or”) unless a specific use to the contrary is explicitly stated.

The particular embodiments disclosed above are illustrative only as the disclosure may be modified and practiced in different but equivalent manners apparent to those skilled in the art having the benefit of the teachings herein. Furthermore, no limitations are intended to the details of construction or design herein shown other than as described in the claims below. It is, therefore, evident that the particular embodiments disclosed above may be altered or modified and all such variations are considered within the scope and spirit of the disclosure. Accordingly, the protection sought herein is as set forth in the claims below.

All locations, sizes, shapes, measurements, ratios, amounts, angles, component or part locations, configurations, dimensions, values, materials, orientations, etc. discussed or shown in the drawings are merely by way of example and are not considered limiting and other locations, sizes, shapes, measurements, ratios, amounts, angles, component or part locations, configurations, dimensions, values, materials, orientations, etc. can be chosen and used and all are considered within the scope of the disclosure.

Dimensions of certain parts as shown in the drawings may have been modified and/or exaggerated for the purpose of clarity of illustration and are not considered limiting.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, machine learning devices, smart phones, smart watches, other devices units designed to perform the functions described herein, or combinations thereof

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” “another example,” “in addition,” “further,” and/or any similar language should be considered to mean that the particular features, structures, or characteristics may be combined in any and all examples in this disclosure. Any combination of any element in this disclosure with any other element in this disclosure is hereby disclosed.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

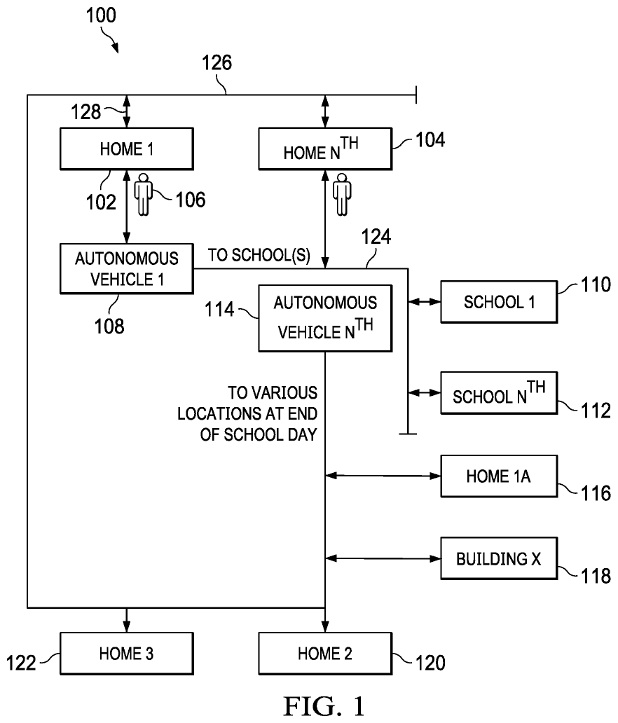

In FIG. 1, an illustration of an autonomous vehicle implementation is shown, according to one embodiment. In this example, an autonomous vehicle implementation 100 may include a first home 102 (or a first location), an Nth home 104 (or an Nth location), one or more people 106, a first autonomous vehicle 108, a first school 110 (or a first government location), an Nth school 112 (or an Nth government location), an Nth autonomous vehicle 114, a first alternative home location 116 (or a first alternative location), a first building 118, a second home 120, a third home 122, a first autonomous vehicle path 124, and/or an Nth autonomous vehicle path 126. In various examples, the first autonomous vehicle 108 does not have a person physically located inside or on the first autonomous vehicle 108. In a first example, the first autonomous vehicle 108 may be driven via a remote control device located in a remote location from the first autonomous vehicle 108. In a second example, the first autonomous vehicle 108 may be driven via one or more processors, one or more LIDAR systems, one or more cameras, one or more detection devices, one or more telematics devices and/or any combination thereof. In a third example, examples 1 and 2 may be combined. In other words, the first autonomous vehicle 108 may utilize one or more processors, one or more LIDAR systems, one or more cameras, one or more detection devices, one or more telematics devices and/or any combination thereof combined with an off-site human to combine both examples.

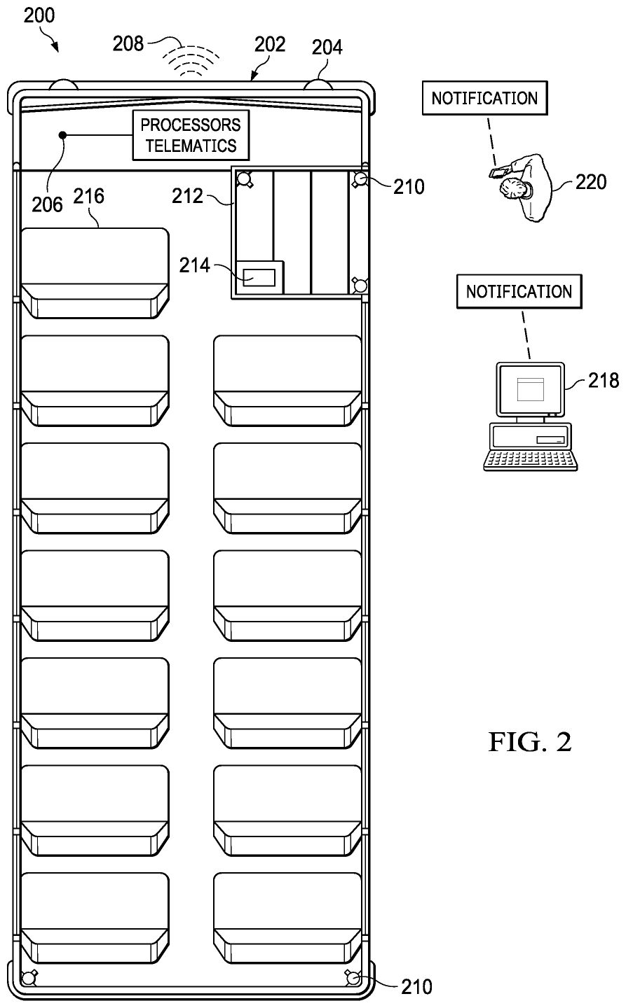

In one example, the first autonomous vehicle 108 stops at the first home 102 at a first time of day and picks up one or more people 106 (e.g., people enter autonomous vehicle 108) which may be combined with the information described in FIG. 2. The autonomous vehicle 108 then may stop at the Nth home 104 at a second time of day and pick up one or more people 106. The autonomous vehicle 108 then may travel to a first school 110 and/or an Nth school 112 and drop off people (e.g., people leave the autonomous vehicle 108) at the first school 110 and/or the Nth school 112 at a third time of day and/or a fourth time of day. In this example, the first autonomous vehicle 106 follows a first autonomous vehicle path 124.

The Nth autonomous vehicle 114 may pick up one or more people at the first school 110 and/or the Nth school 112 at a fifth time of day and/or a sixth time of day. The Nth autonomous vehicle 114 follows an Nth autonomous vehicle path 126 and drops off or picks up one or more people and/or one or more items at a first alternative home location 116, a first building location 118, a second home 120, a third home 112, the first home 102, and/or the Nth home 104.

In one example, a first person (e.g., a child) is picked up by the first autonomous vehicle 108 from the first home 102 at 8 am while a second person (e.g., a second child) is picked up by the first autonomous vehicle 108 from the Nth home 104 at 8.03 am and the first person and the second person are dropped off at the first school 110 at 8.45 am. In this example, when school is over, the first person and the second person are picked up by the Nth autonomous vehicle 114 at 3 pm. The Nth autonomous vehicle 114 drops off the first person to the first alternative home 116 (e.g., grandma's house—with no wolf, dad's house, etc.) and drops off the second person to the Nth home 104. In an alternative example, the second person is dropped off at the first building 118 which may be a gym, a dance class, etc. In addition, one or more packages, pets, and/or any other item and/or thing may be picked up and/or dropped off by the first autonomous vehicle 108 and/or the Nth autonomous vehicle 114. In another example, a person (e.g., parent) can send a message to a scheduling department and/or security department and/or directly to the autonomous vehicle to change a drop off location. For example, a parent has to stay late for work and wants to have their child dropped off at grandma's house.

In FIG. 2, an illustration of an autonomous vehicle utilized to pick up and drop off people 200 is shown, according to one embodiment. In this example, an autonomous vehicle 202 may include one or more cameras 204 (and/or LIDAR system, and/or any detection system, and/or sensors, and/or any combination thereof) which are utilized to drive the autonomous vehicle 202 automatically. In addition, the autonomous vehicle 202 may include one or more processors and/or telematics 206, one or more sensors 208, one or more vehicle internal cameras 210, a security door 212, one or more biometric devices 214, one or more seats 216, an external computer 218, and/or an external mobile device 220.

In one example, a person (e.g., child) enters the autonomous vehicle 202 but cannot enter the internal area until the security door 212 is opened. The security door 212 may be opened based on the child utilized successfully the one or more biometric devices 214. In one example, a person may be monitoring people trying to enter via the security door by utilized the one or more vehicle internal cameras 210 and by-pass the requirement for the child to utilize successfully the one or more biometric devices 214. Once the security door opens, the child may enter the internal area. After the child enters the internal area, the security door is closed for safety purposes. In the event of an emergency where the autonomous vehicle 202 must be exited by the children or people on the autonomous vehicle 202 one or more exits may automatically open up. At the time that a person or child enters and exits the autonomous vehicle 202, one or more notifications may be sent to the external computer 218 and/or the external mobile device 220 to notify a person (e.g., parent, guardian, teacher, etc.) that the person or child has entered or exited the autonomous vehicle 202. In addition, one or more individuals (e.g., parent, guardian, teacher, security officer, etc.) may have access via a computing device to the one or more internal cameras 210 to monitor the status of the people and/or items in the area.

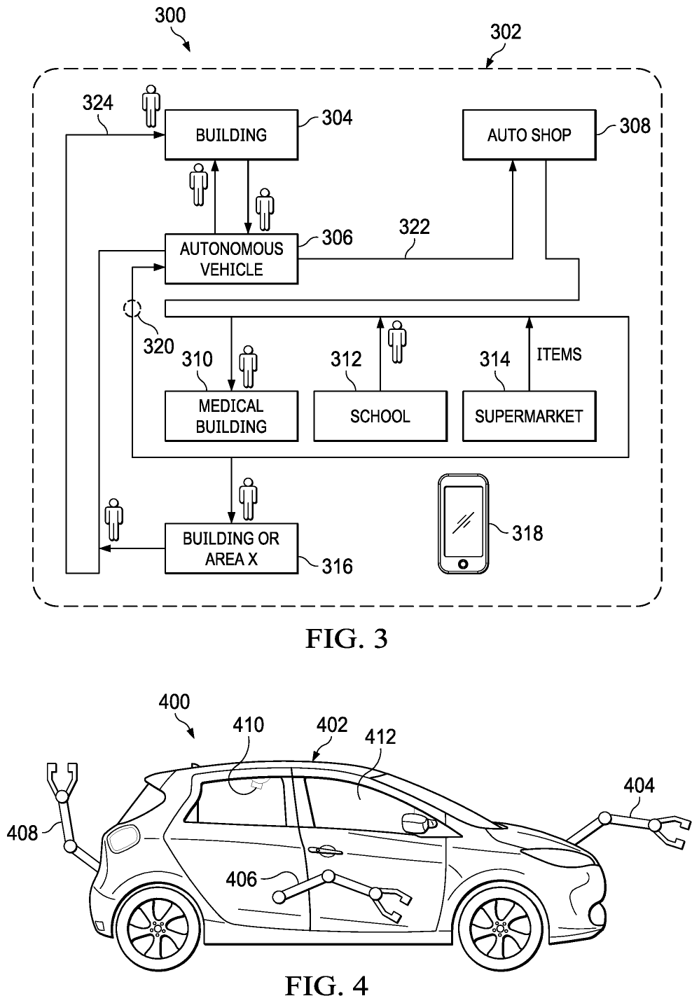

In FIG. 3, another illustration of an autonomous vehicle utilized to pick up and drop off people and/or items 300 is shown, according to one embodiment. In this example, a geofencing area 302 is utilized with a first autonomous vehicle 306 which requires the first autonomous vehicle 306 to stay within the boundaries defined by the geofence. In other words, the first autonomous vehicle 306 is not allowed to leave the geographic area defined by the geofence area 302. In one example, the first autonomous vehicle 306 picks up one or more people and/or one or more items from a first building 304 and then the first autonomous vehicle 306 travels along a first path 322 to an auto shop 308 where one or more people and/or one or more items are dropped off and/or picked up. The first autonomous vehicle 306 proceeds to the first medical building 310 where one or more people and/or one or more items are dropped off and/or picked up. The first autonomous vehicle 306 proceeds to a first school 312 where one or more people and/or one or more items are dropped off and/or picked up. The first autonomous vehicle 306 proceeds to a first supermarket 314 where one or more people and/or one or more items are dropped off and/or picked up. The first autonomous vehicle 306 proceeds to a first building and a first area 316 where one or more people and/or one or more items are dropped off and/or picked up. Alternatively, the first autonomous vehicle 306 proceeds back to the first building 304 but a signal 320 is send to the first building 304 based on locational data of the first autonomous vehicle 306. For example, the signal may initiate one or more HVAC functions of the building, the signal may communicate with an individual in the building that a person will be home in 5 minutes, the signal may initiate any household function (e.g., lights, heating, cooling, coffee maker, etc.). In another example, one or more signals may be sent to the autonomous vehicle to travel to unscheduled places on or near the route but within the geofencing area to pick up and/or drop off people and/or items. These signals may be initiated by one or more people to get picked up (e.g., similar to a driving service, food delivery service, delivery service, etc.)

and/or from a center control center. In one example, the scheduling can be done based on a user profile, traffic patterns, phone profile, time of day, environmental conditions (e.g., rain, snow, etc.), autonomous vehicle capacity, pricing information, and/or any other data in this disclosure.

In FIG. 4, an illustration of an autonomous vehicle with various tools 400 is shown, according to one embodiment. In one example, an autonomous vehicle 402 may include a first movement device 404, a second movement device 406, an Nth movement device 408, one or more directional lights 410, and/or one or more automatic tinting windows 412. In one example, the first movement device 404, the second movement device 406, and/or the Nth movement device 408 may be utilized to transport one or more items and/or people into the autonomous vehicle 402. In another example, the one or more directional lights 410 may be utilized to direct light to a specific person. Further, the one or more automatic tinting windows 412 may maintain a predetermined lumens level in the autonomous vehicle 402.

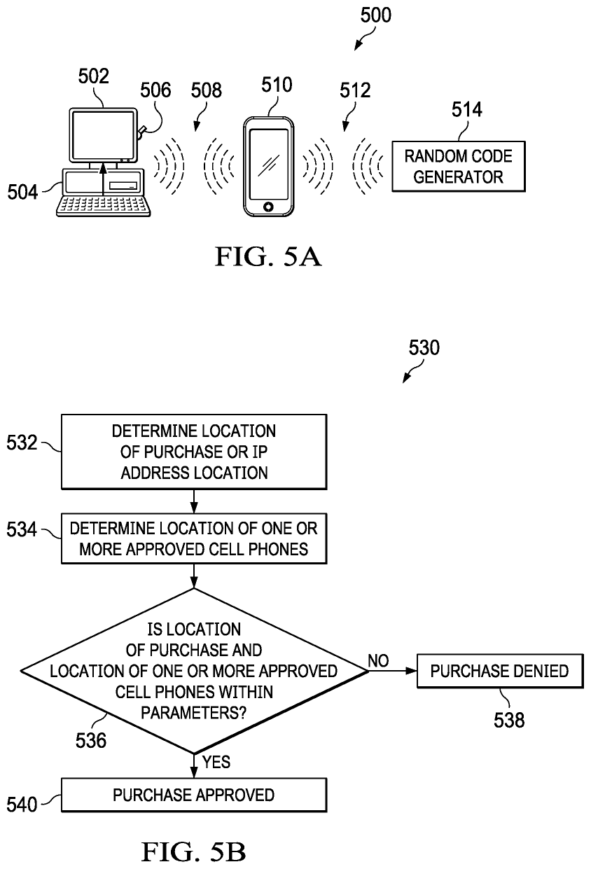

In FIG. 5A, an illustration of a financial transaction process and security system 500 is shown, according to one embodiment. In one example, the security system 500 include a first computer screen 502, a processing and inputting device 504, a switch 506, a first link (e.g., wired or wireless), one or more mobile devices 510, a second link (e.g., wired or wireless), and/or a random number generating device 514 (and/or any other security validation procedure). The security procedure is illustrated in FIG. 5B. A method 530 may include determining a location of purchase (e.g., in person purchase) or an IP address location (e.g., an online purchase) (step 532). The method 530 may include determining a location(s) of one or more approved mobile devices (step 534). The method 530 may include determining via one or more processors whether the location of the purchase and/or the location of the one or more approved mobile devices are within a certain parameter (step 536). If the one or more processors determine that the one or more approved mobile devices are not within the certain parameter, then the purchase is denied (step 538). If the one or more processors determine that the one or more approved mobile devices are within the certain parameter, then the purchase is approved (step 540). In one example, the switch 506 may be virtual or physical and may request a security signal (e.g., random number generated number, etc.) from one or more approved mobile devices in the area.

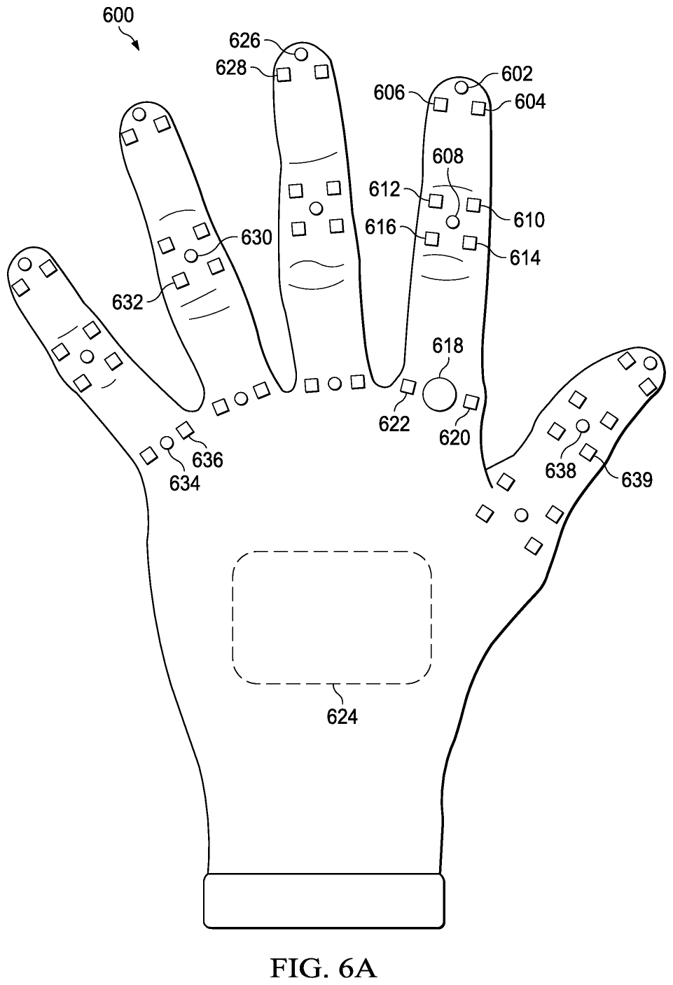

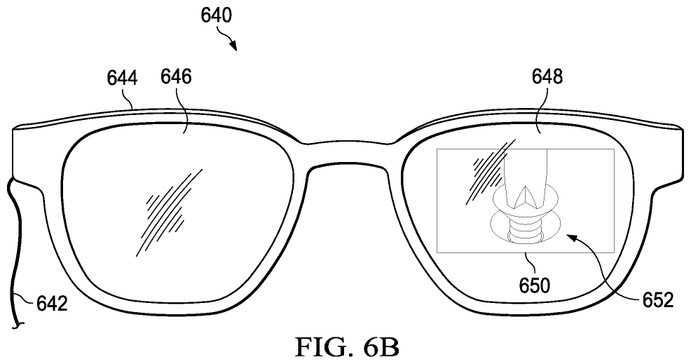

In FIG. 6A, an illustration of a visual aid device is shown, according to one embodiment. In one example, the visual aid device may include a glove 600, a first camera 602, a second camera 608, a third camera 618, a fourth camera 626, a fifth camera 630, a sixth camera 634, a seventh camera 638, and/or an Nth Camera 624. In addition, the visual aid device may include a first light source 604, a second light source 606, a third light source 610, a fourth light source 612, a fifth light source 614, a sixth light source 616, a seventh light source 620, an eighth light source 622, a ninth light source 628, a tenth light source 632, an eleventh light source 636, and/or a twelfth light source 639 (e.g., Nth light source).

In one example, the visual aid device includes the glove 600 with the first camera 602, and the first light source 604. In this example, the first light source 604 may illuminate a target area which the first camera 602 is aiming at. The first camera 602 provides a video stream 652 (and/or image, and/or still image, and/or any other image data) which is display on a heads up display 650 of an eyewear device 644 (See FIG. 6B). The first camera 602 may obtain data from the target area (e.g., work area, body part, an area that cannot be seen easily (e.g., behind the dryer, etc.), and/or any other area). In addition, this video stream 652 (and/or image, and/or still image, and/or any other image data) may be enhanced and/or enlarged for easier viewing. In various examples, the visual aid device could be used for cleaning body parts (e.g., back, etc.), looking into a pipe, allows the user to uses both hands because one hand is not used to hold a light source, shaving, trimming hair and/or hair maintenance, tying shoes, and/or any other hard to see function.

In one example, the eyewear device 644 may include a first lens 646, a second lens 648, support structure 644, and a communication device 642. In one example, the communication device 642 may be wired to the visual aid device and/or the glove 600. In another example, the communication device 642 may be wireless connected to the visual aid device and/or the glove 600. In one example shown in FIG. 6B, the second lens 648 includes the heads up display 650 with the video stream 652 (and/or image, and/or still image, and/or any other image data) while the first lens 646 does not have a heads up display. In another example, the first lens 646 could have a heads up display while the second lens 648 does not have a heads up display. In addition, both the first lens 646 and the second lens 648 could each have a heads up display.

In one example, a person could be working on building a piece of furniture and is unable to see behind the furniture to screw in a screw. Utilizing the visual aid device, the person can see any image or video stream that is in direct line of sight of one or more cameras on glove 600. In another example, a person can toggle through various cameras (e.g., the first camera 602, the second camera 608, the third camera 618, the fourth camera 626, the fifth camera 630, the sixth camera 635, the seventh camera 638, and/or the Nth Camera 624) and/or camera angles (e.g., rotate the first camera 602 by any degrees (−90 degrees to +90 degrees) to obtain the correct image and/or video stream to display on the heads up display 650.

In another example, the glove 600 may utilize the first camera 602 with the second light source 606 and the fifth camera 630 with the tenth light source 632 and the Nth camera 624. In another example, the glove 600 may utilize the seventh camera 638 with the twelfth light source 639 and the third camera 618 with both the seventh light source 620 and the eighth light source 622. Any and all cameras and light sources may be utilized together in any combination. Further, cameras and light sources that do not have reference numbers can be combined together and/or can be combined with cameras and light source that do have reference numbers. The visual aid device can be utilized for working on cars, machinery, construction, for shaving, for hair care (e.g., plucking eyebrows, hair grow treatment, etc.), for body maintenance and/or therapy—to see the area that is being treated (e.g., back, ears, mouth, etc.), and/or for seeing in hard to reach places (e.g., behind dyer, behind refrigerator, under the couch, etc.). It should be noted that any of the cameras and/or lighting sources may be in any position (e.g., knuckle area, phalanges area, little finger area, the ring finger area, the middle finger area, the index finger area, the thumb, the palm, the wrist, and/or any other part of the person) of the glove and/or on the hand.

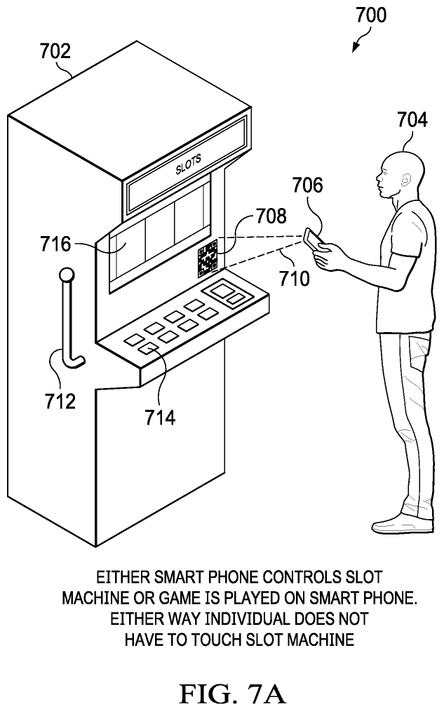

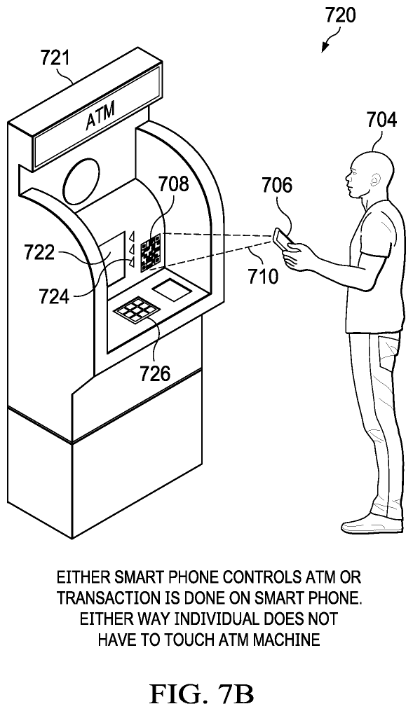

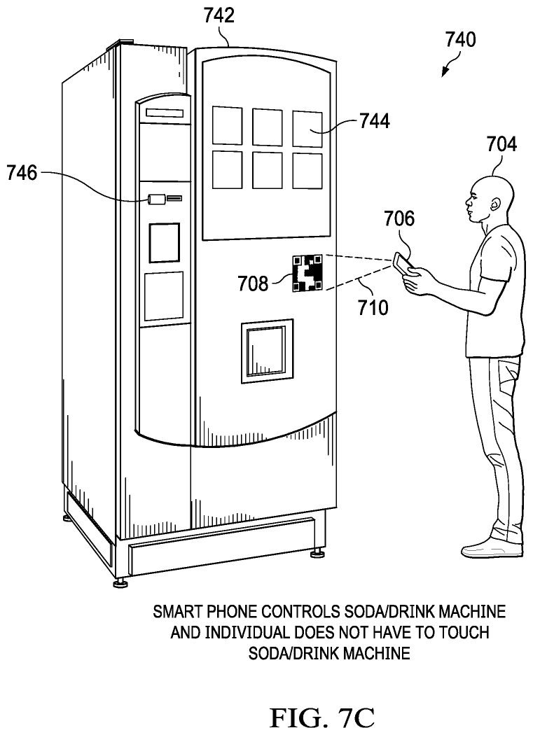

In FIG. 7A, an illustration of touchless transaction device 700 is shown, according to one embodiment. In this example, a slot machine 702 has a pull lever 712, a screen 716, input devices 714, and a communication device 708. In this example, the player 704 can play the slot machine 702 without touching the slot machine 702 by utilizing a mobile device 706 to interact with the communication device 708 via a communication protocol 710. In one example, the mobile device 706 interacts with the slot machine 702 to enter various inputs to play the game on the slot machine 702. In another example, the slot machine 702 transfers and/or displays one or more of the functionality of the pull lever 712, the screen 716, and/or the input devices 714 onto the mobile device 706 to either simulate the slot machine game play on the mobile device 706 and/or accept inputs from the mobile device 706 to initiate game play on the slot machine 702.

In one embodiment, the slot machine may include a processor, a screen, an input device, and a communication device. The communication device configured to communicate with an external device which is in proximity to the slot machine to allow a person to control the slot machine via the external device without touching the slot machine.

In FIG. 7B, another illustration of touchless transaction device 720 is shown, according to one embodiment. In this example, a cash dispensing machine 721 may include a display screen 722, a first set of input devices 724, a second set of input devices 726, and a communication device 708. In one example, the mobile device 706 interacts with the cash dispensing machine 721 to enter various inputs to complete a transaction on the cash dispensing machine 721. In another example, the cash dispensing machine 721 transfers and/or displays one or more of the functionality of the display screen 722, the first set of input devices 724, the second set of input devices 726 onto the mobile device 706 to accept inputs from the mobile device 706 to complete the transaction on the cash dispensing machine 721. In one embodiment, the cash dispensing machine may include a processor, a screen, an input device, and a communication device. The communication device configured to communicate with an external device which is in proximity to the cash dispensing machine to allow a person to control the cash dispensing machine via the external device without touching the cash dispensing machine. In FIG. 7C, an illustration of touchless transaction device 740 is shown, according to one embodiment. In this example, a drink dispensing machine 742 may include a display screen 744, an input device 746, and the communication device. In one example, the mobile device 706 interacts with the drink dispensing machine 742 to enter various inputs to complete a drink dispensing transaction on the drink dispensing machine 742. In another example, the drink dispensing machine 742 transfers and/or displays one or more of the functionality of the display screen 744 and the input device 746 onto the mobile device 706 to accept inputs from the mobile device 706 to complete the transaction on the drink dispensing machine 742.

In one embodiment, the drink dispensing machine may include a processor, a screen, an input device, and a communication device. The communication device configured to communicate with an external device which is in proximity to the drink dispensing machine to allow a person to control the drink dispensing machine via the external device without touching the drink dispensing machine.

In FIGS. 7A-7C, the communication may be via blue tooth, near field, WIFI, radio frequency, and/or any other communication functionality.

FIG. 1 shows an autonomous vehicle system with a first autonomous vehicle picking up one or more students at a first home. The first autonomous vehicle then goes to an Nth home to pick up one or more students. The first autonomous vehicle then goes to a first school to drop off one or more students. Further, the first autonomous vehicle goes to one or more schools including an Nth school to drop off one or more students.

Later in the day and/or close of the school day, an Nth autonomous vehicle goes to the first school and/or the Nth school to pick up one or more students. The Nth autonomous vehicle drops one or more students off at a 1A home (e.g., after school care, babysitter, grandmother's house, etc.). The Nth autonomous vehicle may drop one or more students off at building X (e.g., a gym, dance class, etc.). The Nth autonomous vehicle may then drop off one or more students at a second home, a third home, the first home, and/or the Nth home.

FIG. 2 shows an autonomous bus with a navigation system (e.g., LIDAR, radar, etc.), a safety zone, a biometrics device, one or more processors, one or more telematics, one or more cameras/sensors, seats, and an exit. In one example, the safety zone is enclosed and will not let an individual pass unless their biometrics are confirmed. This allows the children in the bus to be safe from unauthorized personnel. An individual may be verified via the one or more cameras/sensors, biometrics, and/or any other verification procedure. Once the individual is allowed on the bus, one or more notifications may be sent to a parent, the school, the government, and/or any other party. In addition, once the individual is allowed to leave the bus, one or more notifications may be sent to the parent, the school, the government, and/or any other party.

FIGS. 6A and 6B are illustrations of a camera system on a glove with glasses to see in areas that are difficult to normal see in. For example, a person back, close up for shaving, tools in a tight spot, seeing behind something (e.g., washer/dryer, etc.), tying shoes, looking in ears, etc.

In one embodiment, the visual aid device may include a glove; a first camera located at a first position on a first part of the glove; and eyewear including a heads up display where the eyewear being in communication with the first camera to provide data for display on the heads up display.

In another example, the visual aid device may include a processor in communication with the camera and the heads up display. In another example, the visual aid device may include a first light source located at a second location on a second part of the glove. In another example, the visual aid device may include at least one of a second camera located at a third location on a third part of the glove configured to provide data for display on the heads up display, a third camera located at a fourth location on a fourth part of the glove configured to provide data for display on the heads up display, a fourth camera located at a fifth location on a fifth part of the glove configured to provide data for display on the heads up display, an Nth camera located at a sixth location on a sixth part of the glove configured to provide data for display on the heads up display, a second light source located at a seventh location on a seventh part of the glove, a third light source located at an eighth location on an eighth part of the glove, a fourth light source located at a ninth location on a ninth part of the glove, and/or an Nth light source located at a tenth location on a tenth part of the glove. Further, the visual aid device may include an input device which allows a user to toggle between the first camera, the second camera, the third camera, the fourth camera, and the Nth camera to determine whether the first camera, the second camera, the third camera, the fourth camera, and/or the Nth camera provide data for display to the heads up display. In addition, the visual aid device may include an input device configured to adjust an angle of the first camera. In another example, the visual aid device may include a first light source located at a second location on a second part of the glove and an input device configured to adjust an angle of the first light source. In another example, the visual aid device may include a first light source located at a second location on a second part of the glove and an input device configured to adjust an angle of the first light source. Further, the heads up display may be located in a lens of the eyewear or in both lens of the eyewear. In another example, the visual aid device may include a second camera where the second camera has a different size then the first camera.

In another embodiment, a visual aid device may include a first camera located at a first position on a first part of a hand on a person and eyewear including a heads up display where the eyewear being in communication with the first camera to provide data for display on the heads up display.

In another example, the visual aid device may include a processor in communication with the camera and the heads up display. In another example, the visual aid device may include a first light source located at a second location on a second part of the hand on the person. In another example, the visual aid device may include at least one of a second camera located at a third location on a third part of the hand configured to provide data for display on the heads up display, a third camera located at a fourth location on a fourth part of the hand configured to provide data for display on the heads up display, a fourth camera located at a fifth location on a fifth part of the hand configured to provide data for display on the heads up display, an Nth camera located at a sixth location on a sixth part of the hand configured to provide data for display on the heads up display, a second light source located at a seventh location on a seventh part of the hand, a third light source located at an eighth location on an eighth part of the hand, a fourth light source located at a ninth location on a ninth part of the hand, and/or an Nth light source located at a tenth location on a tenth part of the hand. In another example, the visual aid device may include an input device which allows a user to toggle between the first camera, the second camera, the third camera, the fourth camera, and the Nth camera to determine whether the first camera, the second camera, the third camera, the fourth camera, and/or the Nth camera provide data for display to the heads up display. In another example, the visual aid device may include an input device configured to adjust an angle of the first camera. In another example, the visual aid device may include a first light source located at a second location on a second part of the hand and an input device configured to adjust an angle of the first light source. In another example, the visual aid device may include a first light source located at a second location on a second part of the hand and an input device configured to adjust an angle of the first light source. In another example, the heads up display may be located in a lens of the eyewear or in both lens of the eyewear. In another example, the visual aid device may include a second camera where the second camera has a different size then the first camera.

1. A visual aid device comprising:
a glove;
a first camera located at a first position on a first part of the glove;
eyewear including a heads up display, the eyewear being in communication with the first camera to provide data for display on the heads up display.

2. The visual aid device of claim 1, further comprising:
a processor in communication with the camera and the heads up display.

3. The visual aid device of claim 1, further comprising:
a first light source located at a second location on a second part of the glove.

4. The visual aid device of claim 1, further comprising:
at least one of a second camera located at a third location on a third part of the glove configured to provide data for display on the heads up display, a third camera located at a fourth location on a fourth part of the glove configured to provide data for display on the heads up display, a fourth camera located at a fifth location on a fifth part of the glove configured to provide data for display on the heads up display, an Nth camera located at a sixth location on a sixth part of the glove configured to provide data for display on the heads up display, a second light source located at a seventh location on a seventh part of the glove, a third light source located at an eighth location on an eighth part of the glove, a fourth light source located at a ninth location on a ninth part of the glove, and an Nth light source located at a tenth location on a tenth part of the glove.

5. The visual aid device of claim 4, further comprising:
an input device which allows a user to toggle between the first camera, the second camera, the third camera, the fourth camera, and the Nth camera to determine whether the first camera, the second camera, the third camera, the fourth camera, and the Nth camera provide data for display to the heads up display.

6. The visual aid device of claim 1, further comprising:
an input device configured to adjust an angle of the first camera.

7. The visual aid device of claim 6, further comprising:
a first light source located at a second location on a second part of the glove and an input device configured to adjust an angle of the first light source.

8. The visual aid device of claim 1, further comprising:
a first light source located at a second location on a second part of the glove and an input device configured to adjust an angle of the first light source.

9. The visual aid device of claim 1, wherein the heads up display is located in a lens of the eyewear.

10. The visual aid device of claim 1, further comprising:
a second camera where the second camera has a different size then the first camera.

11. A visual aid device comprising:
a first camera located at a first position on a first part of a hand on a person;
eyewear including a heads up display, the eyewear being in communication with the first camera to provide data for display on the heads up display.

12. The visual aid device of claim 11 further comprising:
a processor in communication with the camera and the heads up display.

13. The visual aid device of claim 11, further comprising:
a first light source located at a second location on a second part of the hand on the person.

14. The visual aid device of claim 11, further comprising:
at least one of a second camera located at a third location on a third part of the hand configured to provide data for display on the heads up display, a third camera located at a fourth location on a fourth part of the hand configured to provide data for display on the heads up display, a fourth camera located at a fifth location on a fifth part of the hand configured to provide data for display on the heads up display, an Nth camera located at a sixth location on a sixth part of the hand configured to provide data for display on the heads up display, a second light source located at a seventh location on a seventh part of the hand, a third light source located at an eighth location on an eighth part of the hand, a fourth light source located at a ninth location on a ninth part of the hand, and an Nth light source located at a tenth location on a tenth part of the hand.

15. The visual aid device of claim 14, further comprising:
an input device which allows a user to toggle between the first camera, the second camera, the third camera, the fourth camera, and the Nth camera to determine whether the first camera, the second camera, the third camera, the fourth camera, and the Nth camera provide data for display to the heads up display.

16. The visual aid device of claim 11, further comprising:
an input device configured to adjust an angle of the first camera.

17. The visual aid device of claim 16, further comprising:
a first light source located at a second location on a second part of the hand and an input device configured to adjust an angle of the first light source.

18. The visual aid device of claim 11, further comprising:
a first light source located at a second location on a second part of the hand and an input device configured to adjust an angle of the first light source.

19. The visual aid device of claim 11, wherein the heads up display is located in a lens of the eyewear.

20. The visual aid device of claim 11, further comprising:
a second camera where the second camera has a different size then the first camera.
